(19) United States
(12) Patent Application Publication
(10) Pub. No.: US 2015/0073817 A1
(43) Pub. Date: Mar. 12, 2015

(54) BILLING SYSTEM AND METHOD

(71) Applicant: Gyu Hyung Hwang, Syosset, NY (US)

(72) Inventor: Gyu Hyung Hwang, Syosset, NY (US)

(21) Appl. No.: 14/151,359

(22) Filed: Jan. 9, 2014

Related U.S. Application Data
(60) Provisional application No. 61/874,422, filed on Sep. 6, 2013.

(51) Int. Cl. G06Q 50/22; G06Q 30/04

(52) U.S. Cl. CPC G06Q 50/22; G06Q 30/04
USPC 705/2

(57) ABSTRACT

The present invention relates to a method and system for billing a payer for a healthcare service provided by a healthcare service provider to a patient using a computerized billing system. More particularly, a first biometric scan of the patient is taken and stored in at least one storage device located locally in at least one location associated with the healthcare service provider. At least one second biometric scan of the patient is taken in conjunction with a healthcare service session to be provided to the patient by the healthcare service provider and compared to at least one of a plurality of biometric scans stored in the at least one storage device and including the first biometric scan and biometric scans of other patients. The computerized billing system is authorized to issue an invoice to the payer for the healthcare service session if the at least one second biometric scan matches with the first biometric scan.

### CROSS-REFERENCE TO RELATED APPLICATION

This application claims priority to U.S. Application Ser. No. 61/874,422 filed Sep. 6, 2013, the entire disclosure of which is incorporated herein by reference.

### FIELD OF THE INVENTION

The present invention relates to a billing system and method, and more specifically to medical billing systems and methods having anti-fraud features.

### BACKGROUND OF THE INVENTION

When a person becomes injured through an accident (e.g., an automobile accident) caused by another person covered by an insurance policy (e.g., an automobile insurance), the insurer of that insurance policy provides payment for medical and other treatment services that the injured person receives. More particularly, when the injured person visits a healthcare service provider (e.g., a medical doctor, a hospital, a chiropractor, etc.) to receive medical care, his/her information is submitted to the insurer for authorization. Once the insurer issues proper authorization to the healthcare provider, the injured person receives the authorized medical care (e.g., two ½ hour sessions of certain rehabilitation treatment per week for a four-week duration) from the healthcare provider. Thereafter, the healthcare provider submits one or more bills to the insurer for payment.

From the standpoint of insurers, it would be beneficial to ensure that all bills submitted to them are correct and proper. Incorrect bills may be issued through billing or data entry errors. Bogus or fraudulent bills may also be submitted, when no service was provided. For instance, a doctor may submit a bill to an insurer even though the patient did not even visit the doctor's office. To ensure that bills are submitted for treatment sessions that actually took place, some insurers require that each patient sign a document to evidence his/her visit to the doctor's office. However, because such documentation may still be manufactured, such a requirement has not prevented submission of incorrect or fraudulent bills to insurers.

### SUMMARY OF THE INVENTION

In accordance with one embodiment, the present invention provides a method for billing a payer for a healthcare service provided by a healthcare service provider to a patient using a computerized billing system. More particularly, a first biometric scan of the patient is taken and stored in at least one storage device located locally in at least one location associated with the healthcare service provider. At least one second biometric scan of the patient is taken in conjunction with a healthcare service session provided to the patient by the healthcare service provider and compared to at least one of a plurality of biometric scans stored in the at least one storage device and including the first biometric scan and biometric scans of other patients. The computerized billing system is authorized to issue an invoice to the payer for the healthcare service session if the at least one second biometric scan matches with the first biometric scan.

Another embodiment of the present invention involves providing a system adapted for use in billing a payer for a healthcare service provided by a healthcare service provider to a patient. More particularly, the system includes at least one biometric scanning device having a storage device therein. The at least one biometric scanning device is located locally in at least one location associated with the healthcare service provider. The system also includes a billing system for issuing an invoice for a healthcare service session provided by the healthcare service provider to the patient. The at least one biometric scanning device is configured to take a first biometric scan of the patient and to store the first biometric scan in the storage device. The at least one biometric scanning device is also configured to take at least one second biometric scan of the patient in connection with the healthcare service session and to compare the at least one second biometric scan to at least one of a plurality of biometric scans stored in the storage device, the plurality of biometric scans including the first biometric scan and biometric scans of other patients. The computerized billing system is configured to be authorized to issue the invoice to the payer for the healthcare service session if the at least one second biometric scan matches with the first biometric scan.

### BRIEF DESCRIPTION OF THE DRAWINGS

In the drawing figures, which are not to scale, and where like reference numerals indicate like elements throughout the several views:

FIG. 1A is a block diagram illustrating provision of a healthcare treatment or service to a patient by a healthcare service provider and issuance of payment for such treatment by an insurer;

FIG. 1B is a block diagram illustrating a billing system constructed in accordance with an embodiment of the present invention;

FIGS. 2A and 2B illustrate a screen for inputting an insurer's information;

FIG. 3 illustrates a screen listing insurers registered in the billing system;

FIG. 4 illustrates a screen showing information of a certain insurer;

FIG. 5 illustrates a screen listing patients registered in the billing system;

FIGS. 6A and 6B illustrate a screen for registering a new patient in the billing system;

FIG. 7 illustrates a screen for registering a biometric scanning device in the billing system;

FIG. 8 illustrates a screen listing registered patients for associating or registering one or more of the biometric devices registered in the billing system to one or more of the registered patients;

FIG. 9 illustrates a screen for associating or registering one or more of the biometric devices registered in the billing system to a selected patient;

FIG. 10 illustrates a screen showing information of a selected patient;

FIG. 11 illustrates a screen listing authorized services previously added in the billing system for a particular patient;

FIG. 12 illustrates a screen for adding services authorized by an insurer for a particular patient;

FIG. 13 is a block diagram illustrating a process for taking an initial sample biometric scan of a patient;

FIG. 14 is a block diagram illustrating a check-in process;

FIG. 15 is a block diagram illustrating a check-out process; and

FIG. 16 illustrates a screen listing service or treatment sessions performed by a healthcare service provider and showing whether they are ready for billing.

### DESCRIPTION OF EMBODIMENTS OF THE INVENTION

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, and some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; exemplary embodiments are provided merely to be illustrative. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the invention. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

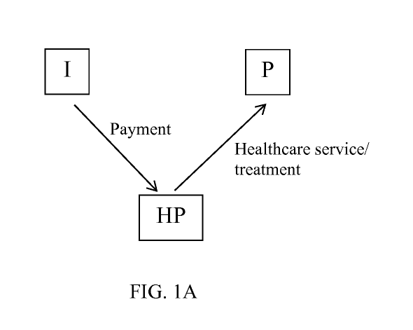

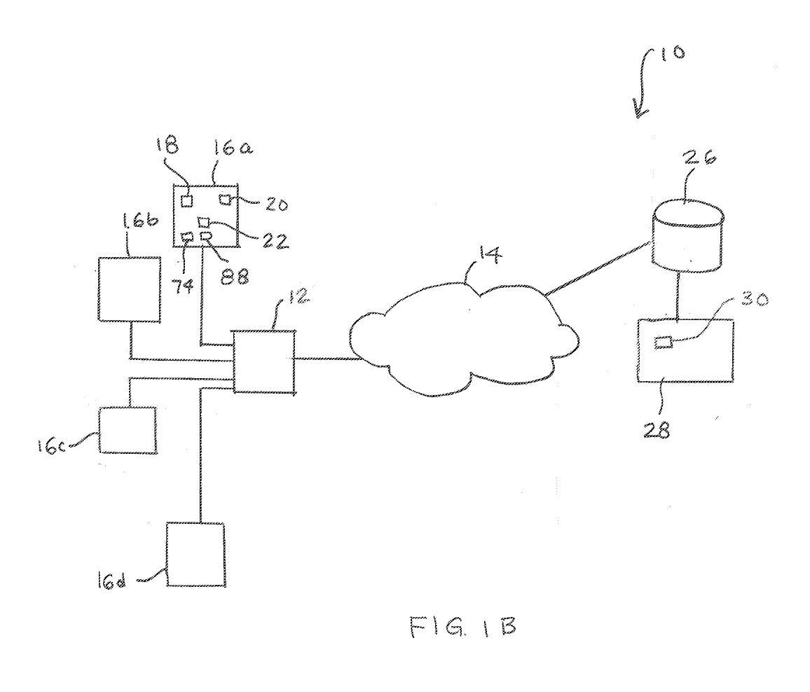

Referring to FIG. 1A, when a patient P receives healthcare service/treatment from a healthcare service provider HP (e.g., a doctor, a hospital, an urgent care center, a surgical center, a rehabilitation center, a mental health center, a dentist, a chiropractor, their staff and assistants, etc.), his/her insurer I pays the healthcare provider HP for the treatment. The insurer I may be the carrier of the patient's own health insurance policy or the carrier of a liability insurance of a third party who caused injury to the patient (e.g., through an automobile accident). Payment for the treatment may alternatively be issued by a governmental or another public or private entity under a public or private healthcare program, such as the Medicaid and Medicare programs. Accordingly, the term “payment provider” or “payer” shall include third party payers providing payment for service or treatment sessions rendered by a healthcare service provider to a patient. Accordingly, healthcare insurance carriers, liability or umbrella policy insurance carriers and payers under public or private healthcare programs are intended to be included within the meaning of the term “payment provider” or “payer”.

FIG. 1B is a block diagram illustrating an exemplary embodiment of a network and devices implementing embodiments of the present invention. Other embodiments that may vary, for example, in terms of arrangement or in terms of type of components, are also intended to be included within the scope of the invention.

With reference to FIG. 1B, there is shown a system 10 for use by a healthcare service provider (e.g., doctors, hospitals, chiropractors, medical or dental offices, etc.) in billing healthcare service or treatment sessions that it provide to its patients. The system 10 includes a client device 12 connected to a network 14, such as a local area network (LAN) and/or wide area network (WAN) (e.g., the Internet). The client device 12 can be located at a location designed by the healthcare service provider. In one embodiment, the client device 12 can be any type of computing and/or communication device, such as a personal computer, a tablet computer, a smartphone, etc. While only one client device 12 is illustrated in FIG. 1B, it is apparent that multiple client devices can be provided in conjunction with an embodiment of the present invention. Moreover, it is envisioned that the system 10 can be used by more than one healthcare provider, each having its own client device or devices.

Biometric devices 16a-16d are connected to the network 14 via the client device 12. In one embodiment, each of the biometric devices 16a-16d may be provided with its own communication device for connection to the network 14. In another embodiment, each of the biometric devices 16a-16d includes an onboard communication device, thereby eliminating the need to provide a separate communication device, such as the client device 12.

Still referring to FIG. 1B, each of the biometric devices 16a-16d can be any type of device capable of capturing or taking one or more biometric measurements or scans of a person. For instance, such devices include fingerprint or palm readers, retina scanners, face-recognition readers or scanners, etc., such as the face-recognition biometric reader sold by ZK Technology LLC, doing business as ZK Software and located in Piscataway, N.J., under the trademark IFACE 302. In one embodiment, each of the biometric devices 16a-16d includes a scanner 18 (e.g., a camera, etc.) for taking a biometric measurement of a person, a microprocessor 20 and a memory (i.e., a storage device) 22. In another embodiment, the microprocessor 20 and/or the memory 22 of each of the biometric devices 16a-16d can be provided in a separate computing device, such as the client device 12. Each of the biometric devices 16a-16d can be powered by an on-board battery (not shown) or can be AC-powered.

The biometric devices 16a-16b are located at locations designated by the healthcare provider, such as different offices in different towns, different locations within a single office, etc. By locating the biometric devices 16a-16d in different locations, patients can use one or more biometric devices 16a-16d according to their preference once authorized for use (see below for a discussion of biometric device authorization). While multiple biometric devices are illustrated in FIG. 1B, in one embodiment, only one biometric device may be used. In another embodiment, additional biometric devices may be provided.

For identification purposes, each of the biometric devices 16a-16d is provided with a unique identifier code or number (e.g., a serial number) that is different from that of every other biometric device 16a-16d. Each of the unique identifier codes is stored in the memory 22 of a corresponding one of the biometric devices 16a-16d.

Still referring to FIG. 1B, the system 10 includes a database 26 and a management server 28. In one embodiment, the database 26 maybe located remotely or locally from the management server 28. The database 26 and the management server 28 communicate with the biometric devices 16a-16d and/or the client device 12 such that the management server 28 and the database 26 can be accessed by the healthcare provider for issuance of bills for healthcare service sessions provided to patients.

The management server 28 includes a management application 30 for managing a billing system associated with the system 10. More particularly, the management application 30 is adapted for use by the healthcare provider or others in managing patient and insurance information and issuing invoices when service or treatment sessions are provided by the healthcare provider.

A computing device may be capable of sending or receiving signals, such as via a wired or wireless network, or may be capable of processing or storing signals, such as in memory as physical memory states, and may, therefore, operate as a server or a client device. Thus, devices capable of operating as a server or a client device may include, as examples, dedicated rack-mounted servers, desktop computers, laptop computers, set top boxes, integrated devices combining various features, such as two or more features of the foregoing devices, or the like. Servers or client devices may vary widely in configuration or capabilities, but generally a server or a client device may include one or more central processing units and memory. A server or a client device may also include one or more mass storage devices, one or more power supplies, one or more wired or wireless network interfaces, one or more input/output interfaces, one or more operating systems, such as Windows® Server, Mac® OS X®, Unix®, Linux®, FreeBSD®, or the like, or one or more software applications for performing its intended function or functions.

The management server 28 may also include a device that includes a configuration to provide content via a network to another device. A server may, for example, host a site, such as Yahoo!®'s web site. A server may also host a variety of other sites, including, but not limited to, business sites, social networking sites, educational sites, dictionary sites, encyclopedia sites, wikis, financial sites, government sites, personal sites, etc.

Servers may further provide a variety of services that include, but are not limited to, web services, third-party services, audio services, video services, email services, instant messaging (IM) services, SMS services, MMS services, FTP services, voice over IP (VOIP) services, calendaring services, photo services, a cloud, or the like. Examples of content may include text, images, audio, video, or the like, which may be processed in the form of physical signals, such as electrical signals, for example, or may be stored in memory, as physical states, for example. Examples of devices that may operate as a server or a client device include desktop computers, multiprocessor systems, microprocessor-type or programmable consumer electronics, etc.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCD30), Bluetooth, 802.11b/g/n, or the like. A wireless network may include virtually any type of wireless communication mechanism by which signals may be communicated between devices, such as a client device or a computing device, between or within a network, or the like.

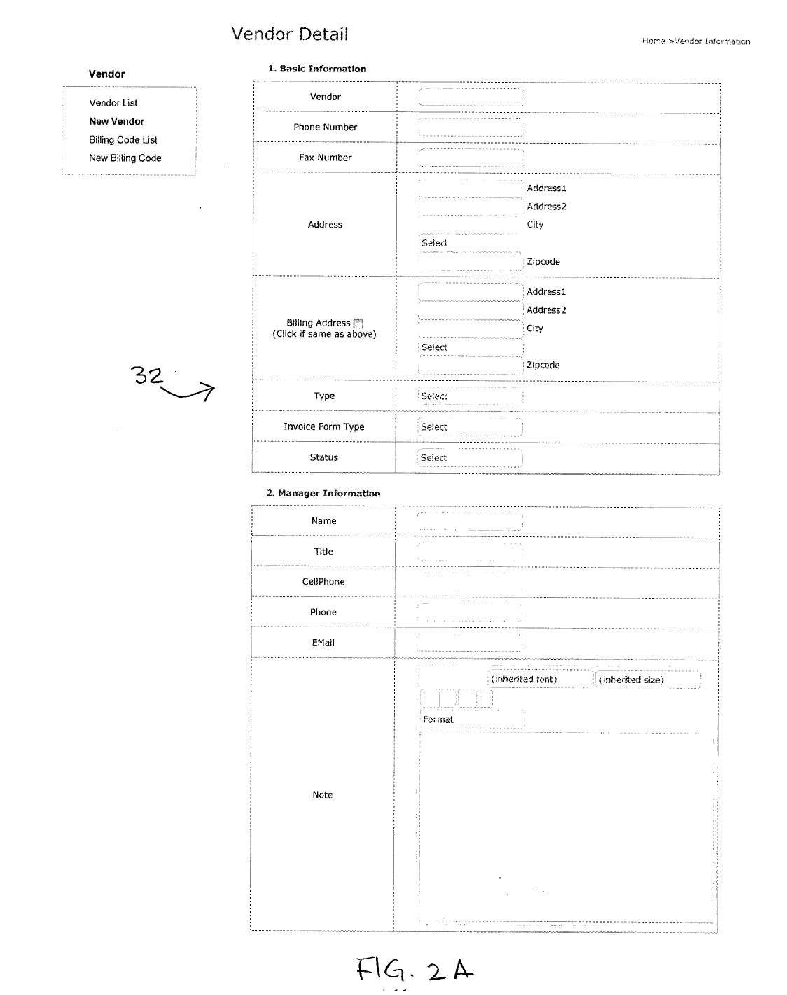

FIGS. 2-16 show screen shots (e.g., webpages) and block diagrams illustrating various systems and processes associated with embodiments of the present invention. These systems and processes are discussed below.

### Insurer Information Adding Process

In one embodiment, the management application 30 residing on the management server 28 is configured for use in setting up a billing system for payers or payment providers, such as insurers (e.g., GEICO, etc.) and the Medicare and Medicaid programs. For instance, the management application 30 provides an insurance entry screen 32 (see FIGS. 2A and 2B) for entering billing information of each payer that the healthcare provider works with. After accessing the management application 30 through the network 14 from the client device 12 or another communication device, the insurer's name, billing address, telephone and fax numbers, invoice form type, etc. (see FIGS. 2A and 2B) are entered into the insurance entry screen 32 (e.g., a webpage). The management application 30 in turn stores the entered insurance information in the database 26. Additional information relating to each payer can be included in the database 26. Moreover, processes for billing under the Medicaid and Medicare programs may also be set up in the billing system of the present invention and stored in the database 26.

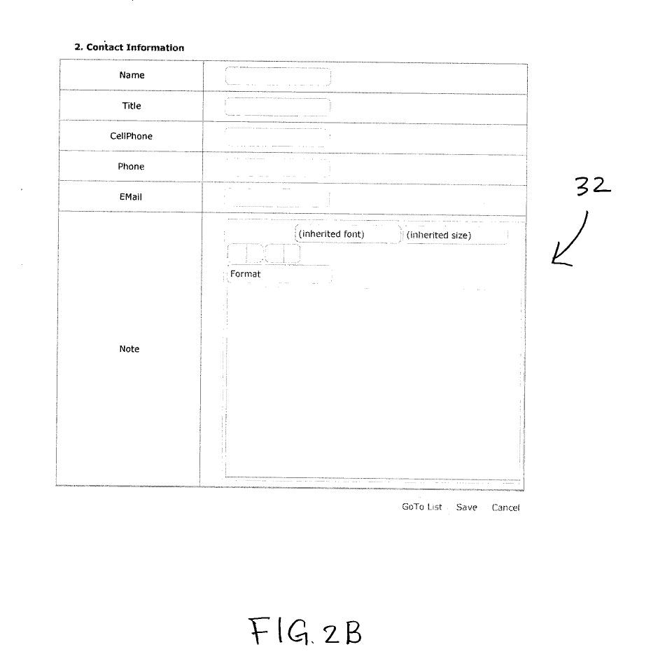

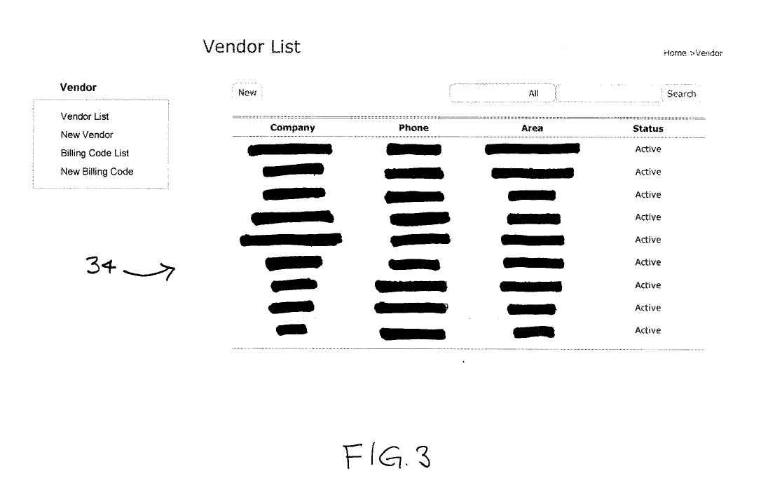

Once payers' information has been stored in the database 26, it can be retrieved for viewing and making changes thereto. FIGS. 3 and 4 illustrate screens 34, 36 (i.e., webpages) provided by the management application 30, listing various payers set up in the billing system (see FIG. 3) and providing the details of a specific payer (see FIG. 4). To allow the healthcare provider to update a payer's information, an editing function (e.g., a button) 38 is provided on the screen 36 (see FIG. 4).

### Patient Registration Process

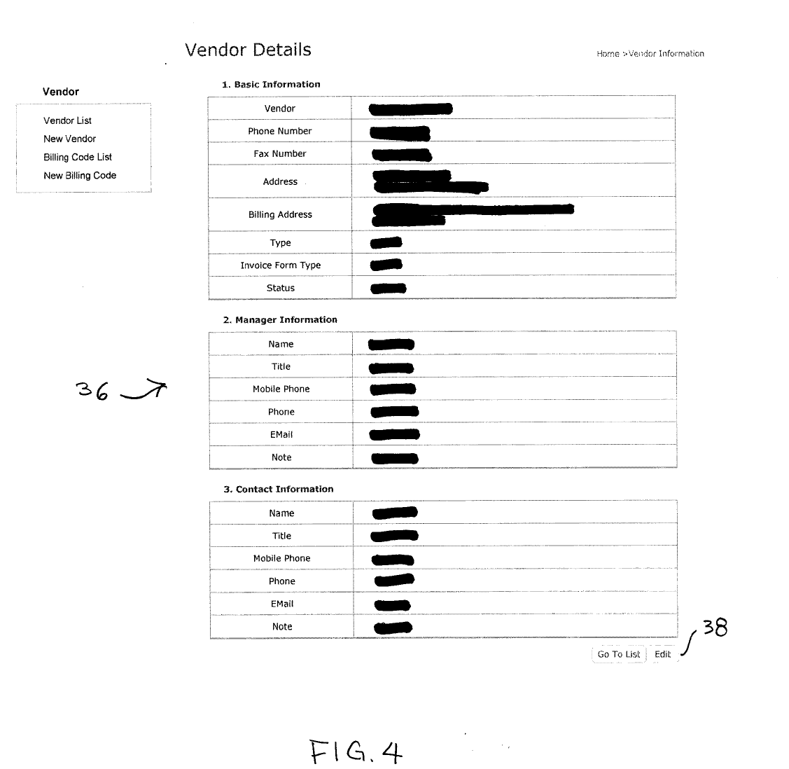

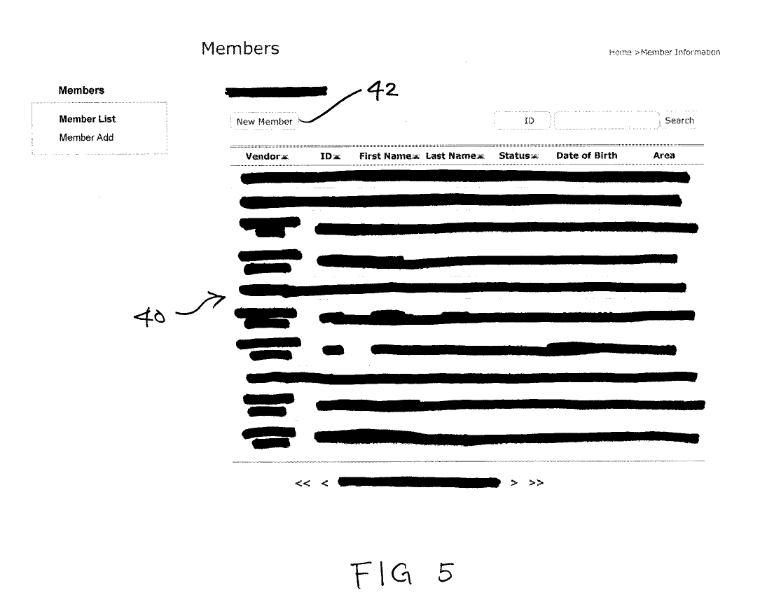

Now referring to FIG. 5, the management application 30 is configured for use in registering (i.e., creating accounts for) new patients in the billing system of the present invention. In this regard, the management application 30 provides a member list screen (e.g., webpage) 40 (see FIG. 5) listing patients already registered in the billing system. In order to create an account for a new patient NP, a new member function 42 (e.g., a button) provided on the member list screen 40 is selected, causing the management application 30 to display a patient information input screen 44 (see FIGS. 6A and 6B). The patient information input screen (e.g., webpage) 44 provides various fields 46 for entering information of the new patient NP, such as an identification number, which is assigned by the healthcare provider, the patient's name, phone numbers, address, medical benefit information (e.g., the date of birth, the social security number, Medicaid or Medicare information (if applicable) and insurer information (if applicable)). Additional information can be entered in the patient information input screen 44 (see, e.g., FIGS. 6A and 6B).

### Biometric Device Registration Process

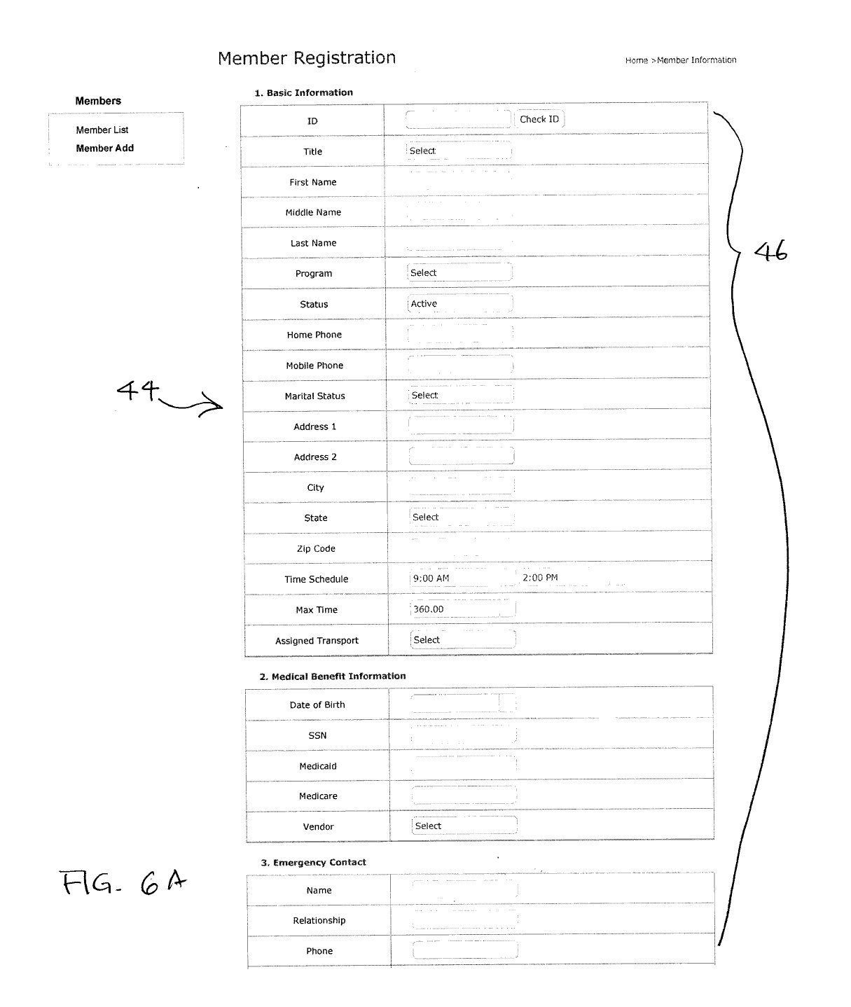

Now referring to FIG. 7, a process for registering the biometric devices 16a-16d in the billing system is described below. The management application 30 provides a biometric device registration screen (e.g., webpage) 48 for entering information regarding each of the biometric devices 16a-16d. For instance, device identification, serial number and IP address information is added to the registration screen 48. The entered information of the biometric devices 16a-16d is stored in the database 26 for use by the billing system.

### Biometric Device Section Process

Once the patient's account has been set up in the management application 30, the patient is assigned with one or more of the biometric devices 16a-16d. For instance, the patient may be authorized to receive service or treatment only from one or more selected offices of the healthcare provider. In such circumstances, the patient is registered to use only certain biometric devices (e.g., those biometric devices located in the designated offices or physical locations).

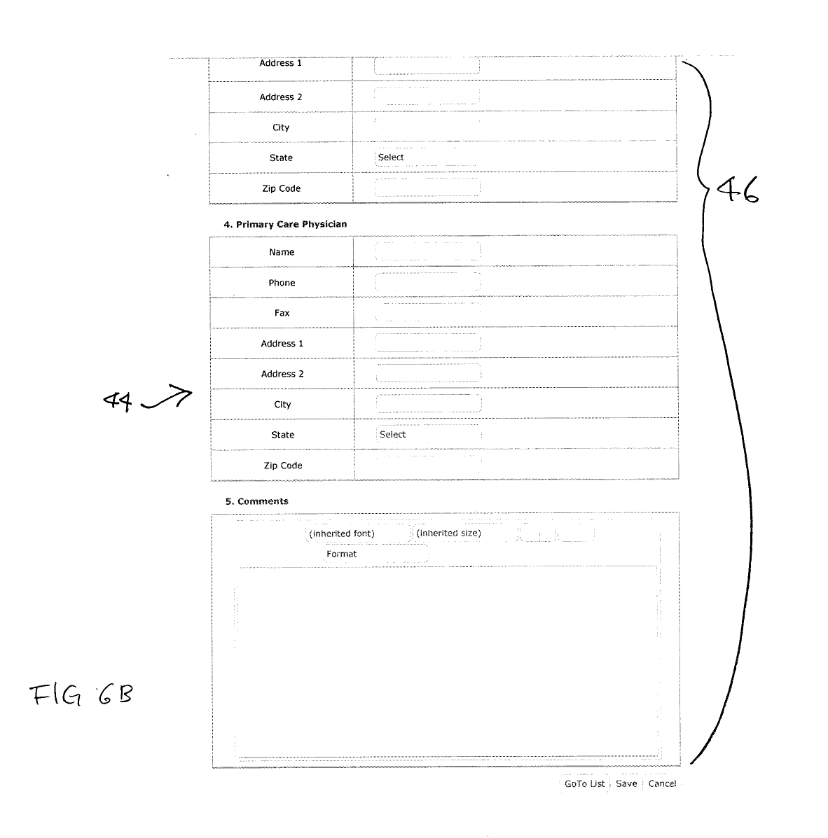

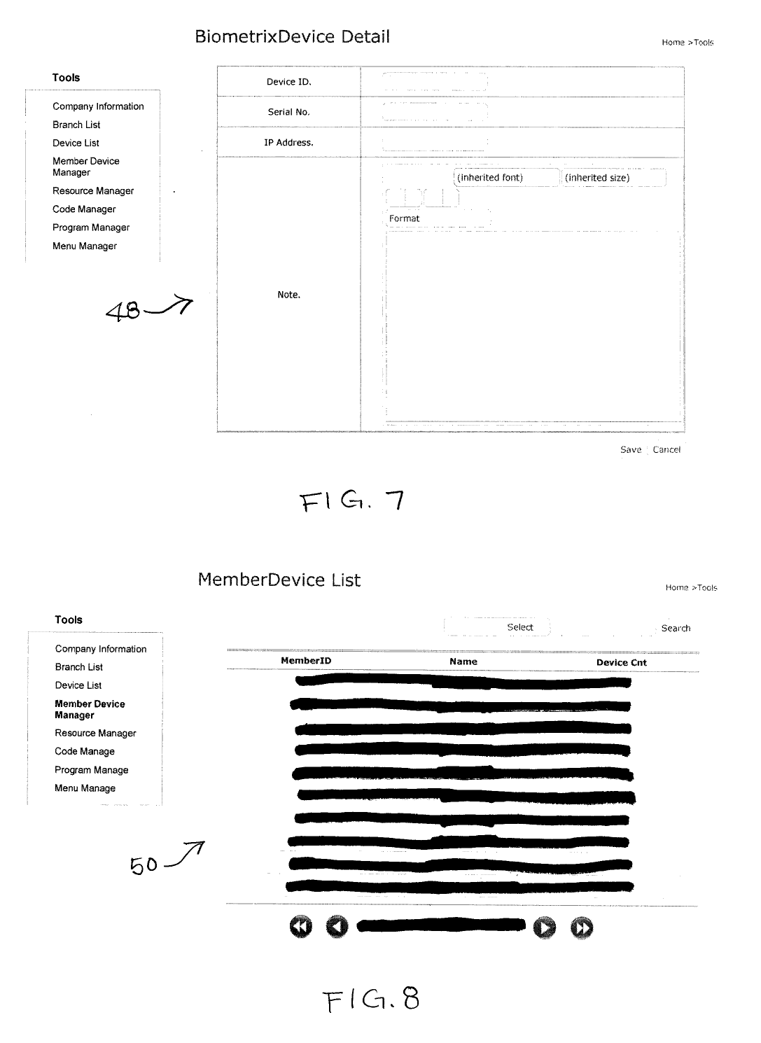

In order to register the patient with a designated one or set of the biometric devices 16a-16d, the management application 30 provides a device list screen (e.g., webpage) 50 listing patients registered in the billing system (see FIG. 8). A desired one of the listed patients is selected from the device list screen 50, causing the management application 30 to display a device list screen (e.g., webpage) 52 for the selected patient (see FIG. 9). The device list screen 52 lists all biometric devices registered in the billing system for the healthcare provider (e.g., the biometric devices 16a-16d), including their identification numbers, serial numbers, IP addresses and status. The device list screen 52 also provides selection boxes 54 for registering or un-registering (i.e., adding or deleting) the selected patient to or from one or more of the biometric devices 16a-16d. An appropriate section is made for each of the biometric devices 16a-16d in a corresponding one of the selection boxes 54. If one or more of the biometric devices 16a-16d is registered or assigned to the patient, the management application 30 then records the corresponding registration/assignment information in the database 26. In response, the management application 30 (or another component of the billing system) communicates with the added biometric devices to store certain information of the selected patient (e.g., the member identification number, name, etc.) in the memory 22 of the added biometric devices 16a-16d, thereby allowing the patient to use the added biometric devices 16a-16d. Such patient information is not sent or downloaded to the other biometric devices 16a-16d (i.e., the non-added biometric devices) such that the patient is not allowed to use any of them.

When one or more of the added biometric devices 16a-16d is de-selected (i.e., removed) from the device list screen 52, the management application 30 (or another component of the billing system) communicates with the deselected biometric devices so as to delete the information of the patient from the memory 22 of each deselected device. As a result, the patient can no longer use any such biometric device once it is deselected in the device list screen 52.

### Authorization Process

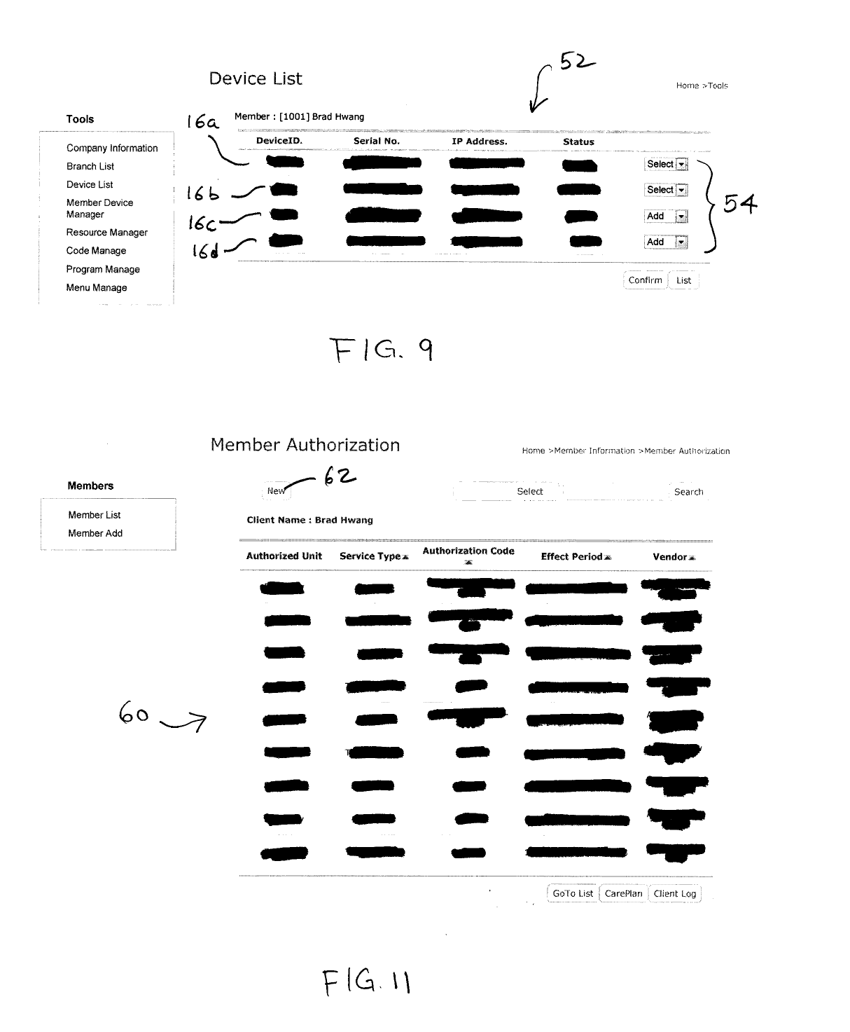

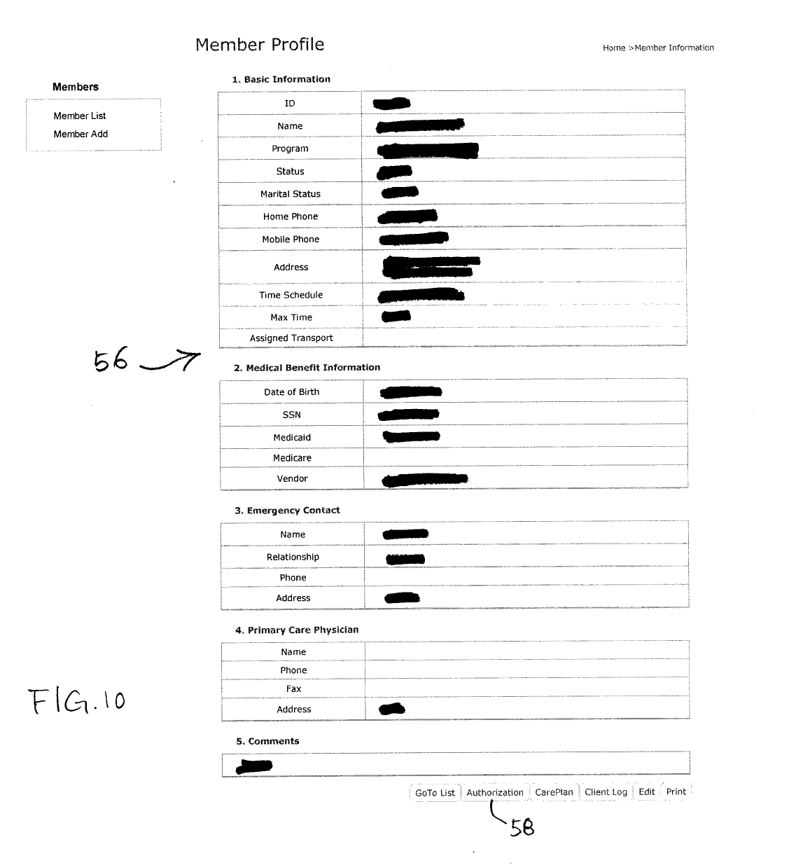

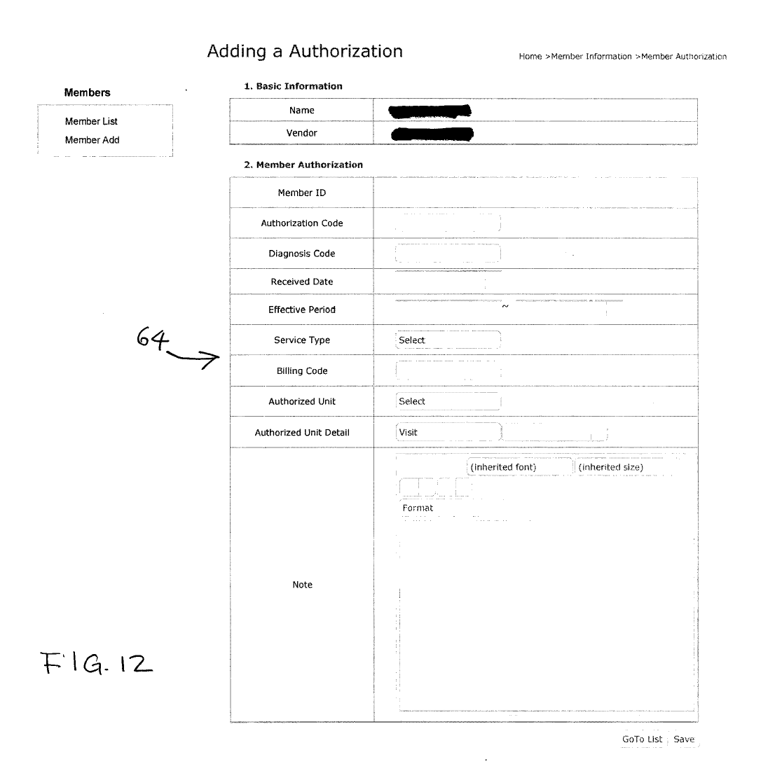

Once the patient's account has been set up in the billing system as discussed above, a request for authorization is sent to the patient's insurer or payer in a conventional manner. For instance, the request may be made via telephone, mail, website or other conventional manners. Once the insurer provides authorization (e.g., one or more authorization codes) for the treatments requested, a corresponding one of the patients listed on the member list screen 40 (see FIG. 5) is selected. In turn, the management application 30 displays a patient profile screen (e.g., webpage) 56 so that the patient's information can be viewed, an authorization code can be added and other changes can be made to the patient's profile (see FIG. 10). An authorization function 58 provided on the patient profile screen 56 is selected to be routed to a patient authorization screen or webpage 60 (see FIG. 11). To add each authorized service or treatment, a new service function 62 provided on the patient profile screen or webpage 60 is selected such that the management application 30 provides or displays an authorization screen or webpage 64 (see FIG. 12) for entering the required authorization information (e.g., the patient's member identification, authorization code, diagnosis code, etc.). When a save function provided on the authorization screen 64 is selected, the management system 30 stores the entered authorization information in the database 26.

### Initial Biometric Scan Process

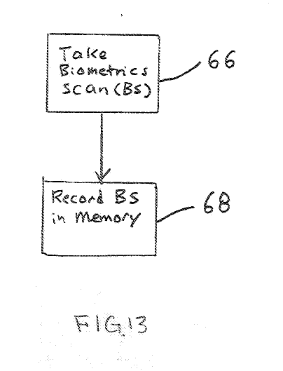

With reference to FIG. 13, as part of the patient registration process discussed above in conjunction with FIGS. 6A and 6B, a sample biometric measurement or scan of the patient is taken by one of the biometric devices registered for use by the patient (see block 66 in FIG. 13). The biometric device used in this process is one of the biometric devices added to the patient's account as discussed above in connection with FIG. 9 above (referred to hereinafter as “the authorized biometric device”). The scan is then associated with the identification number of the patient stored in the memory 22 of the authorized biometric device and stored locally in the memory 22 in connection with the patient's identification number (see block 68 in FIG. 13). In one embodiment, the scan is stored locally only in the memory 22 of the authorized biometric device so as to safeguard the patient's biometric information. If the patient is authorized to use more than one biometric devices, then the scan can be stored in the memory 22 of each authorized biometric device. In another embodiment, the scan may be sent to the management server 28 which records same in the account record of the patient stored in the database 26. The scan may be a biometric scan of the patient's face, or other biometric scans, such as fingerprint or palm scans, retina scans, etc., may be used.

### Patient Check-In/Check-Out Process

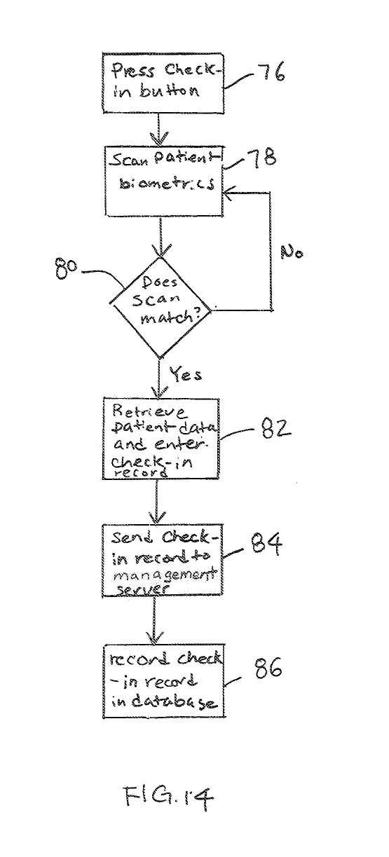

With reference to FIG. 14, before receiving service or treatment from the healthcare provider, the patient checks in using any of the biometric devices that are assigned or authorized to him. More particularly, a check-in button 74 (see FIG. 1; see also block 76 in FIG. 14) provided on the authorized biometric device is actuated so that a biometric scan of the patient can be taken (see block 78 in FIG. 14). The biometric device then processes the scan to determine whether it matches with any biometric scans of the patients stored in its memory 22 (see block 80 in FIG. 14). If no match is found, the biometric device takes additional scans of the patient for a predetermined number of times, after which it gives an error message to seek assistance. If a match is found, the biometric device automatically enters in its memory 22 a check-in record including the check-in time (i.e., the time at which the record is made), the identification number of the matching patient and the identification number (i.e., serial number) of the biometric device itself (see block 82 in FIG. 14). In one embodiment, the check-in record is sent in real time to the management server 28 or another component of the billing system (see block 84 in FIG. 14), which, in turn, records same in the account record of the patient stored in the database 26 (see block 86 in FIG. 14). In another embodiment, the check-in record is uploaded to the management server 28 in batch together with other check-in or check-out records. The check-in record sent to the management server 28 does not include any biometric scan of the patient so as to safeguard the patient's biometric information.

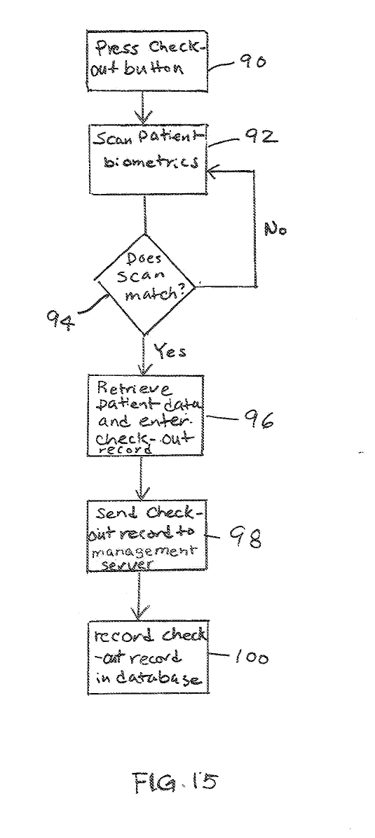

Now referring to FIG. 15, after the patient receives a service session from the healthcare provider, he checks out using any of the authorized biometric devices. More particularly, a check-out button 88 (see FIG. 1) on the biometric device is actuated (see block 90 in FIG. 15) so that a biometric scan of the patient can be taken by the biometric device (see block 92 in FIG. 15). The biometric device then processes the scan to determine whether it matches with any biometric scans of the patients stored in its memory 22 (see block 94 in FIG. 15). If no match is found, the biometric device takes additional scans of the patient for a predetermined number of times, after which it displays an error message to seek assistance. If a match is found, the biometric device automatically enters in its memory 22 a check-out record including the check-out time (i.e., the time at which the check-out record is made), the identification number of the matching patient and the identification number (i.e., serial number) of the biometric device itself (see block 96 in FIG. 15). In one embodiment, the check-out record is also sent in real time to the management server 28 or another component of the billing system (see block 98 in FIG. 15), which, in turn, records same in the account record of the patient stored in the database 26 (see block 100 in FIG. 15). In another embodiment, the check-out record is uploaded to the management server 28 in batch together with other check-in or check-out records stored in the memory 22 of the biometric device. The check-out record sent to the management server 28 does not include any biometric scan of the patient so as to safeguard the patient's biometric information.

In one embodiment, the check-in and check-out records are sent to the management server 28 in real time. In another embodiment, the check-in and/or check-out records are sent after a predetermined time. For instance, if there is a network failure such that the management server 28 is unable to communicate with the client device 12 and hence the biometric devices 16a-16d, uploading of the check-in and check-out records can be suspended until such communication is restored. Since the check-in and check-out records are stored locally in the memories 22 of the biometric devices 16a-16d, there is no risk of losing any check-in or check-out data. The management server 28 also ensures synchronization of the check-in and check-out records between the memories 22 of the biometric devices 16a-16d and the database 26 such that data error is minimized.

### Billing Process

After or during the provision of a healthcare service or treatment session, the healthcare provider (e.g., a doctor or his staff) enters proper billing information (e.g., billing code or codes and other information corresponding to the service rendered) in the billing system via the management application 30. That is, the healthcare provider accesses the management application 30 to retrieve the check-in record stored in the database 26 for the service being provided and enters the necessary billing information to same so as to create a service billing record for each specific service session. When the patient checks out properly by creating a check-out record for the session as discussed above in connection with FIG. 15, the management application 30 adds the check-out record to the service billing record to reflect that the session is ready for billing. When the necessary billing information for a specific service session is entered after a check-out record has been created and/or stored in the database 26 for that session, the service billing record is immediately ready for billing.

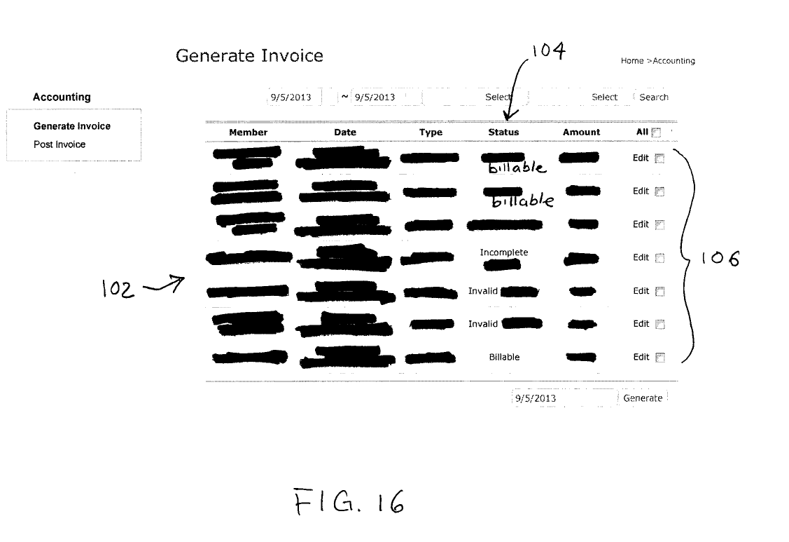

In order to issue an invoice for the session, the healthcare provider accesses the management application 30 residing on the management server 28. In this regard, an invoice generating screen or webpage 102 is provided (see FIG. 16) by the management application 30. The invoice generating screen 102 lists all sessions of service or treatment provided to the healthcare provider's patients. The invoice generating screen 102 lists the patient, date of service, status (e.g., billable, incomplete, etc.) and other information relating to the previously completed service or treatment sessions. However, the management application 30 shows only those sessions that have proper check-in and check-out records (i.e., appropriate check-in and check-out biometric scans were taken for each session) as being billable (see column 104 in FIG. 16). The management application 30 does not allow billing of any other sessions (i.e., those lacking proper check-in or check-out records or not conforming to the insurers' authorization). The healthcare provider selects a desired one or set of the billable sessions for invoicing by selecting an invoice generating function 106 provided on the invoice generating screen 102. In response, the management application 30 creates proper invoices for the selected sessions.

As discussed above, the management application 30 allows billing of service or treatment sessions only when proper check-in and check-out records are received from one of the biometric devices 16a-16c authorized to a specific patient. That is, the management application 30 requires that the presence of a patient at a service session be authenticated or confirmed before an invoice for that session can be issued. Accordingly, the management application 30 prevents issuance of fraudulent bills for sessions that were never provided. Also, the check-in and check-our records of the present invention include check-in and check-out times, the serial numbers of the biometric devices used for checking in and checking out and the biometric scans taken at the time of check-in and check-out. As a result, since an audit can be conducted to compare these records to the healthcare provider's invoices issued for related treatment sessions, the billing system of the present invention provide an additional protection against fraudulent billing practice. In addition, since the check-in and check-our records of the present invention are automatically generated and cannot be manipulated, their accuracy can be assured.

As illustrated above, the entire billing process from the time the patient checks in for a treatment session to the issuance of an invoice for same is substantially automated, thereby making same user-friendly. Also, the billing system of the present invention could be located at a third party server and accessed, used and managed (e.g., addition, modification or deletion of certain patient or device information) by the healthcare provider via the Internet, thereby eliminating the need for the healthcare provider to purchase expensive hardware or software. In an alternate embodiment, the billing system of the present invention can reside entirely in a server or system owned by the healthcare provider.

Each of the biometric devices 16a-16d has its unique serial number and is registered to the healthcare provider. As a result, the activities of the biometric devices 16a-16d may be reviewed or examined on a provider-by-provider basis. Moreover, the management of multiple biometric devices (e.g., the biometric devices 16a-16d) is performed through a single system (i.e., the management application 30). In addition, the biometric devices 16a-16d are located at predetermined physical locations associated with the healthcare service provider.

Those skilled in the art will recognize that the methods and systems of the present invention may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the invention covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

I claim:

1. A method of billing a payer for a healthcare service provided by a healthcare service provider to a patient using a computerized billing system, said method comprising the steps of:
taking a first biometric scan of the patient;
storing the first biometric scan in at least one storage device located locally in at least one location associated with the healthcare service provider;
taking at least one second biometric scan of the patient in conjunction with a healthcare service session provided to the patient by the healthcare service provider;
comparing the at least one second biometric scan to at least one of a plurality of biometric scans stored in the at least one storage device, said plurality of biometric scans including the first biometric scan and biometric scans of other patients; and
authorizing the computerized billing system to issue an invoice to the payer for the healthcare service session if the at least one second biometric scan matches with the first biometric scan during the performance of said comparing step.

2. The method of claim 1, wherein the plurality of biometric scans are stored only in the at least one storage device for retrieval during the performance of said comparing step.

3. The method of claim 2, wherein the at least one storage device includes a plurality of storage devices, each of which is physically located in the at least one location of the healthcare service provider, the at least one location including a first location at which the healthcare service session is to be provided to the patient by the healthcare service provider.

4. The method of claim 1, wherein said step of taking the first biometric scans is performed using at least one biometric scanning device, the at least one storage device being integrated in the at least one biometric scanning device.

5. The method of claim 4, wherein said step of taking the at least one second biometric scan is performed using the at least one biometric scanning device.

6. The method of claim 5, wherein the at least one biometric scanning device includes a plurality of biometric scanning devices, the at least one storage device including a plurality of storage devices, each of which is integrated in a corresponding one of the plurality of biometric scanning devices.

7. The method of claim 1, wherein the at least one second biometric scan includes a pre-session biometric scan of the patient and a post-session biometric scan of the patient, said step of taking the at least one second biometric scan including the steps of taking the pre-session biometric scan at or prior to the initiation of the healthcare service session and taking the post-session biometric scan at or after the completion of the healthcare service session.

8. The method of claim 7, wherein said comparing step includes the steps of comparing the pre-session biometric scan to at least one of the plurality of biometric scans and comprising the post-session biometric scan to at least one of the plurality of biometric scans.

9. The method of claim 8, further comprising the steps of creating a first attendance record if the pre-session biometric scan matches with the first biometric scan during the performance of said step of comparing the pre-session biometric scan to at least one of the plurality of biometric scans and creating a second attendance record if the post-session biometric scan matches with the first biometric scan during the performance of said step of comparing the post-session biometric scan to at least one of the plurality of biometric scans, each of the first and second attendance records including a time stamp corresponding to the time at which a corresponding one of the pre-session and post-session biometrics scans was taken and a patient identifier corresponding to the patient.

10. The method of claim 9, further comprising the steps of transmitting the first attendance record to the billing system and transmitting the second attendance record to the billing system.

11. The method of claim 10, wherein the billing system is authorized to issue the invoice for the healthcare session only when the first and second attendance records are received by the billing system.

12. The method of claim 10, wherein the billing system is located remotely from the at least one location of the healthcare service provider, the billing system being accessed by the healthcare service provider via a communication network.

13. The method of claim 9, wherein each of the first and second attendance records excludes any biometric information.

14. A system adapted for use in billing a payer for a healthcare service provided by a healthcare service provider to a patient, said system comprising at least one biometric scanning device including a storage device therein, said at least one biometric scanning device being located in at least one location associated with the healthcare service provider; and a billing system for issuing an invoice for a healthcare service session provided by the healthcare service provider to the patient, said at least one biometric scanning device being configured to take a first biometric scan of the patient and to store the first biometric scan in said storage device, said at least one biometric scanning device being configured to take at least one second biometric scan of the patient in connection with the healthcare service session and to compare the at least one second biometric scan to at least one of a plurality of biometric scans stored in said storage device, the plurality of biometric scans including the first biometric scan and biometric scans of other patients, said computerized billing system being configured to be authorized to issue the invoice to the payer for the healthcare service session if the at least one second biometric scan matches with the first biometric scan.

15. The system of claim 14, wherein the plurality of biometric scans are stored only in the storage device for retrieval when the at least second biometric scan is compared to one of the plurality of biometric scans.

16. The method of claim 15, wherein said at least one biometric scanning device includes a plurality of biometric scanning devices, each of which includes a storage device for storing a plurality of biometric scans therein.

17. The method of claim 14, wherein the at least one second biometric scan includes a pre-session biometric scan of the patient and a post-session biometric scan of the patient, said biometric scanning device being configured to take the pre-session biometric scan at or prior to the initiation of the healthcare service session, to compare the pre-session biometric scan to at least one of the plurality of biometric scans, to create a first attendance record if the pre-session biometric scan matches with the first biometric scan and to transmit the first attendance record to said billing system, said at least one biometric scanning device being configured to take the post-session biometric scan at or after the completion of the healthcare service session, compare the post-session biometric scan to at least one of the plurality of biometric scans, to create a second attendance record if the post-session biometric scan matches with the first biometric and to transmit the second attendance record to the billing system, each of the first and second attendance records including a time stamp corresponding to the time at which a corresponding one of the pre-session and post-session biometrics scans was taken and a patient identifier corresponding to the patient.

18. The system of claim 17, wherein said at least biometric scanning device is configured to transmit each of the first and second attendance records such that the first and second attendance records can be received by said billing system, said billing system being configured such that it is authorized to issue the invoice for the healthcare session only when the first and second attendance records are received by the billing system.

19. The system of claim 18, wherein said billing system is located remotely from the at least one location of the healthcare service provider, said billing system being accessed by the healthcare service provider via a communication network.

20. The system of claim 17, wherein each of the first and second attendance records excludes any biometric information.
